(19) United States
(12) Patent Application Publication
(10) Pub. No.: US 2006/0148568 A1
(43) Pub. Date: Jul. 6, 2006

(54) Device and method for wirelessly accessing game media

(75) Inventors: Charles P. Schultz, North Miami Beach, FL (US); James L. Tracy, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/027,893

(22) Filed: Dec. 30, 2004

(51) Int. Cl. A63F 13/00

(52) U.S. Cl. 463/42; 463/29; 463/43

(57) ABSTRACT

A video game system (100) includes one or more game carousels (101), one or more physical game media (118), and one or more game consoles (112). The game carousel (101) is capable of holding one or more game media (118). The game console (112) wirelessly requests, from the game carousel (101), access to game code associated with a game media (118). If the game media (118) is physically present in, or in communication with, the game carousel (101), access is granted and at least a portion of the game code is wirelessly transmitted from the game carousel (101) to the game console (112). Once the game media (118) is removed from, or stops communication with, the game carousel (101), or if the game carousel (101) and game console (112) stop communication with each other, game play is terminated at the game console (112).

### BACKGROUND OF THE INVENTION

1. Field of the Invention

This invention relates in general to video game distribution and more particularly, to wireless video game distribution systems that monitor user activity.

2. Description of the Related Art

A video game is a set of instructions executed by a game console that allows game play to take place through a display of graphics. A user control interface on the game console allows the player to interact with the video game. Video games are well known throughout the world and are available in an almost unlimited choice of objectives, from very simple games that teach children how to spell, to extremely complex, virtual reality, multi-player, 3-dimensional action games.

Prior-art game consoles include a processor that executes instructions, which are provided to the game console by placing them on a particular storage medium, which is then introduced into the game console. Accordingly, previous game consoles were enabled to accept and read a single particular type of medium so the instructions could be interpreted and followed. For instance, some games are encoded onto a Compact Disc (CD), others onto a Digital Video Disc (DVD), others onto a hardwired cartridge, as well as other formats.

Each game console was able to read one medium only and only one media object at any given time. Because most gamers wish to play a variety of games, the gamer who had purchased and owned a plurality of games had to physically replace the media in the gaming console when switching operation from one game to another.

Accordingly, a need exists for a device and method for wirelessly accessing a plurality of games without having to physically interchange the game media in order to access each game selected.

### SUMMARY OF THE INVENTION

According to an exemplary embodiment of the present invention, a system comprises at least one physical gaming media, which includes a game, at least one game carousel, and at least one game console for playing a video game. The game carousel includes a media interface operable to accept multiple physical media and a wireless data communication transceiver. The game console also includes a memory, a processor, a display, and a wireless data communication transceiver.

The game console is operable to send, through the wireless data communication transceiver on the game console, a request to the game carousel for wireless access to the physical gaming media, and the game carousel is operable to receive, through the wireless data communication transceiver on the game carousel, the request from the game console and to transmit to the game console at least a portion of the game if the physical gaming media is present on the game carousel. If the physical media is removed from the game carousel, the game is deleted or uninstalled from the game console, and game play is halted.

The game console, in accordance with another exemplary embodiment of the present invention, includes a clock/timer module which the game console uses to periodically query, through the wireless data communication transceivers, whether the physical gaming media is present on the game carousel, and whether the game carousel and game console are within a predetermined maximum distance of separation while the game console is authorized to use a game associated with a game media on the game carousel, and wherein the game console terminates game play on the game console if no response or a negative response is returned from the game carousel, or if the game console receives a termination message from the game carousel at any time.

The system, in another example, includes a licensing parameter associated with the physical media. The licensing parameter specifies the number of game consoles that may access the physical media at a single time and the number of instances a single game console can access a particular game. The game carousel is operable to compare the licensing parameter to the number of requestors requesting access to a single physical media and prevent the number of game consoles accessing the game from exceeding the licensing parameter.

An intermediate device, such as a cellular phone, according to another exemplary embodiment, can access the game code contained on the physical media in the game carousel and can allow game carousels to access the game code directly from the intermediate device. The intermediate device is able to follow the licensing parameters for each particular game and deny access to game consoles requesting access to the game that would violate the license for that game. If multiple game consoles are requesting access to a game with a license that prevents access to all requesting consoles, the intermediate device can decide which consoles are to be given access based on a variety of priority parameters.

In accordance with another embodiment of the present invention, a method comprises wirelessly transmitting, from at least one game console to a game carousel, a request for access to a game stored on a physical media; confirming, at the game carousel, that the physical media is present on the game carousel; wirelessly transmitting, upon confirmation that the physical media is present on the game carousel, to the at least one game console, at least a portion of the game; monitoring the physical media for removal from the game carousel and halting, by deleting from memory or otherwise, an execution of the game at each of the game consoles if the physical media is removed from the game carousel.

According to another embodiment of the present invention, a method comprises wirelessly comparing a licensing parameter to the number of game consoles requesting access to the physical media, and the number of instances each console is accessing the game, and granting preference based on the proximity to the location of the physical media, and denying access to each game console requesting access after the licensing parameter has been exceeded.

A method, in another example, comprises wirelessly recording in a memory at least one of a game console identifier, a date, a time, the number of sessions, and an amount of game play time for each game console that is granted access to the game.

A method, according to another example, comprises halting, by deleting from memory or otherwise, game execution on the game console if the game console and the game carousel exceed a specified distance from each other.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a system according to an exemplary embodiment of the present invention;

FIG. 2 is a block diagram illustrating various media formats according to exemplary embodiments of the present invention;

FIG. 3 is a block diagram illustrating a game carousel in accordance with an embodiment of the present invention;

FIG. 4 is a block diagram illustrating an embodiment of the present invention shown in FIG. 1;

FIG. 5 is a block diagram illustrating a specific embodiment of the system of FIG. 1;

FIG. 6 is block diagram illustrating the cellular telephone of FIG. 5;

FIG. 7 is block diagram illustrating an intermediate device and game console according to an embodiment of the present invention;

FIG. 8 is block diagram illustrating one embodiment of the devices shown in FIG. 7;

FIG. 9 is block diagram illustrating a system according to an embodiment of the present invention;

FIG. 10 is block diagram illustrating another system according to another exemplary embodiment of the present invention;

FIG. 11 is block diagram illustrating a wireless game console, including a game cartridge, according to an embodiment of the present invention;

FIG. 12 is a block diagram showing a wireless game media/plug-in cartridge, according to an exemplary embodiment of the present invention;

FIG. 13 is a block diagram showing a wireless game media/carousel according to another example of the present invention;

FIG. 14 is an operational flow diagram showing a wireless game access operational sequence according to an exemplary embodiment of the present invention;

FIG. 15 is an operational flow diagram showing wireless game access operational sequence according to another exemplary embodiment of the present invention; and

FIG. 16 is block diagram illustrating an exemplary system according to the present invention.

FIG. 17 is block diagram illustrating a wearable strap supporting multiple wireless game cartridges, according to an embodiment of the present invention.

FIG. 18 is block diagram illustrating a wearable necklace supporting multiple wireless game cartridges, according to an embodiment of the present invention.

FIG. 19 is block diagram illustrating a wireless game cartridge including a clip for attachment to clothing, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, software code, game code, and the like as used herein, are defined as a sequence of instructions designed for execution on a computer system, a processor, and/or a controller. A program, computer program, or software application may include a subroutine, a function, a procedure, an object method, an object implementation, an executable application, an applet, a servlet, a midlet, a driver, a source code, an object code, a shared library/dynamic load library and/or other sequence of instructions designed for execution by a processor. A predefined access criteria, as used herein, is defined as any of configuration data stored in memory, jumper or switch settings that are readable by a processor and/or a controller, and/or other access control mechanism for configuring computing parameters for specifying preemption of access of game code for a plurality of users in accordance with a priority scheme, as will be discussed in more detail below. A licensing parameter may include configuration data stored in memory, jumper or switch settings that are readable by a processor and/or a controller, and/or other license control mechanism for specifying conditions for access of game code by one or more users in accordance with a legal license contract associated with the game code.

The present invention, according to an embodiment, overcomes problems with the prior art by providing a wireless game carousel that accommodates multiple game-containing media simultaneously and can wirelessly communicate game information with one or more remote game consoles that request access to one of the games currently residing within the game carousel in one or more languages and/or formats. The game carousel is also provided with a database of information, including licensing parameters associated with each game, which game consoles may access a game, and which game consoles are currently accessing a game. In this manner, the carousel can prevent unauthorized sharing of a game.

Physical Media Distributed via Game Carousel

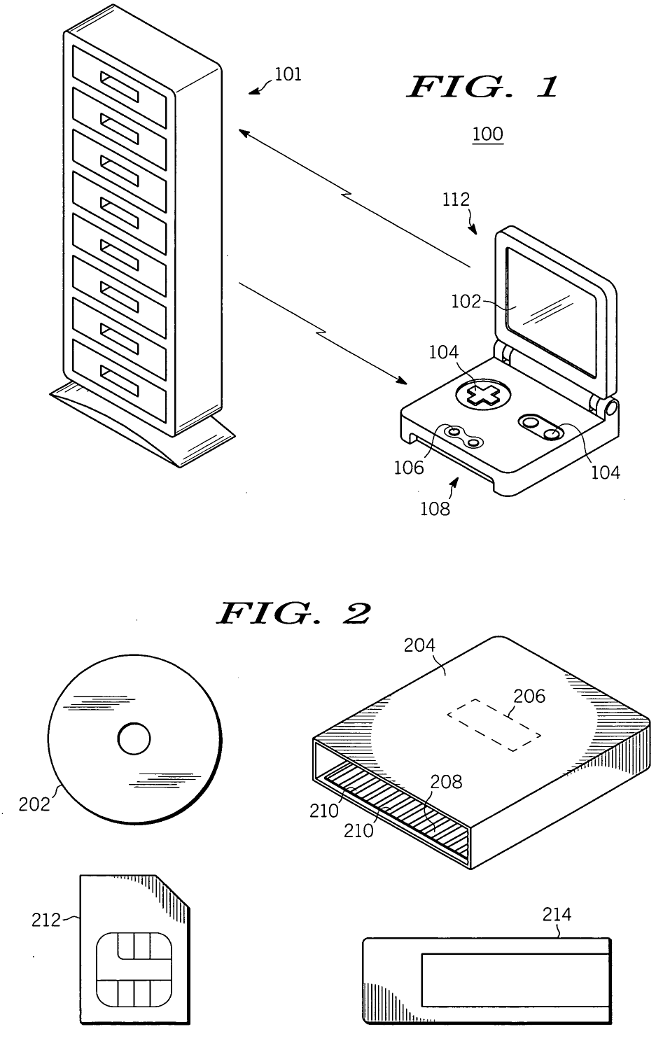

According to an exemplary embodiment of the present invention, as shown in FIG. 1, a wireless entertainment media system 100 includes a game carousel 101, or game containing device, and a remote game console 112. The system 100 can also include any number of additional remote game consoles, pieces of game media, and game carousels. In the example of a system 100 shown in FIG. 1, the game carousel 101 is a device that holds multiple purchased games in the form of physical game media (not shown), which may be provided in multiple formats. To accommodate the multiple formats, the carousel 101 is provided with a plurality of interconnect types for accepting the multiple physical embodiments of the game formats.

The game console 112 and the game carousel 101 communicate with each other using at least one of wired communication and wireless communication. Any remote game console 112 that is within a specified communication range, or able to establish reliable communication, can access the games within the game carousel 101, provided certain licensing conditions are met, as will be explained in detail below. The game carousel 101 is also capable of simultaneously transmitting game code to multiple consoles 112 in the same or different transmission formats.

Media

Although many different media formats are used as are well known in the art, four exemplary media formats will be discussed herein for providing example and not for limitation of alternative embodiments of the present invention in any way. Referring now to FIG. 2, media format 202 is a Compact Disc Read Only Memory (CDROM or CD), which is well known in the art and typically comprises a device for storing data in an optically recognizable format. The CD 202 surface is a mirror covered with billions of tiny bumps that are arranged in a long, tightly wound spiral. A CD reader reads the bumps with a precise laser and interprets the information as bits of data.

Similarly, media format 202 could be DVD technology, which has the same physical shape and works similar to a CDROM. However, DVDs hold about 4.7 gigabytes of information, which equals roughly seven times as much information as a CD can hold. DVDs can hold more data than CDs because the bumps are smaller and the tracks are closer together, giving DVDs more storage space. Other DVD-like formats, such as UMDs are able to hold even more information by providing multiple layers of storage space.

A second media format, 204, is a game cartridge, which is well known by those having ordinary skill in the art. Common game cartridges 204 include a ROM 206, which stores the game instructions. An interface 208 has a plurality of conductive areas 210 that electrically couple the ROM 206 to the game carousel 101 so that the game instructions can be read and interpreted by a processor in the game carousel 101.

A third example of media format for use as a video game media, 212, is a SIM card. SIM cards are well known in the art and contain Flash memory.

A fourth and final example of media format for the present discussion is shown in FIG. 2 as a memory card 214. The memory card 214, like the SIM card 212, contains Flash memory, which is used for fast and easy data storage. Flash memory is known in the art and can be found in such devices as digital cameras, digital voice recorders, and PCMCIA Type I and Type II memory cards.

Of course, as will be appreciated by those of ordinary skill in the art in view of the present discussion, a system according to the present invention will work equally as well with other game storage media formats not specifically described above, such as, Magnetic media, Compact Flash, Memory Sticks, SD Cards, SIM/USIM, and the like.

The particular alternative media format used to store one or more games may be selected by design choice as a function of the game size, a manufacturer's marketing decisions, or other commercial and technical considerations as will be well understood by those of ordinary skill in the art in view of the present discussion. Software requirements for running a game have evolved from the rendering of elementary rectangular boxes in the original Pong™ game, to the richly-textured, full-color graphics and video, multi-channel surround sound, multi-player interactive, virtual-reality games of today. It is the exponential increase in storage capacity each consecutive year in the state-of-the-art media that has allowed game developers to so drastically improve the quality and reality of the games they create. All of the media formats described in the preceding paragraph, as well as many others not described here, for purposes of the present discussion, are capable of storing an entire video game of information. However, the features may be limited due to the lower storage capacity of formats such as a magnetic medium 214. Additionally, game information can be separated into executable code and game resource data. The resource data can be purchased, licensed, or loaded incrementally during game play, such as when a new level is reached or a new mission is selected.

Game Carousel

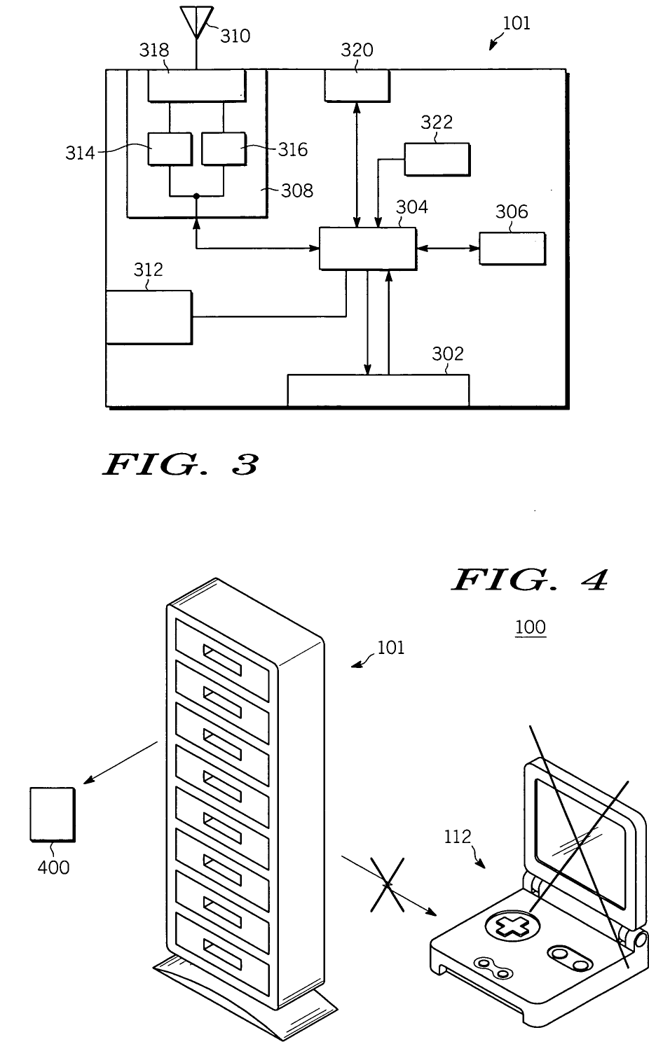

Referring now to FIG. 3, the game carousel 101 will be discussed in more detail below. Game carousel 101 includes a Central Processing Unit (CPU) (also known as a controller and/or a processor) 304, a Random Access Memory (RAM) 306, a software operating system (not shown), a media interface 302, a transceiver 308, a port for wired communication 320, an antenna 310, a clock-timer module 322, and a power supply 312.

The CPU 304 is the heart of the game carousel 101. The CPU is a microprocessor that for purposes of the present discussion does three basic things:
1: The CPU 304 performs mathematical operations like addition, subtraction, multiplication and division. Modem CPUs contain complete floating point processors that can perform extremely sophisticated operations on large floating point numbers;
2: The CPU 304 moves data from one memory location to another; and
3: The CPU 304 makes decisions and jumps to a specific set of instructions based on those decisions.

The CPU 304 receives its timing from a clock-timer module 322. RAM (random-access memory) 306 is shown in FIG. 3 and normally can hold large amounts of information, including executable game code (software) information, configuration parameters, and other data. The CPU 304 is communicatively coupled to, and can read from and write data to, the RAM 306. Video game systems rely on RAM to provide temporary storage of games as they are being played. Without RAM, it would be a strain for even the fastest CPU 304 to provide the necessary speed for an interactive gaming experience. In one embodiment, a large amount of RAM is not needed in the game carousel 101, since game play and processing takes place in the game console 112. Note that memory, such as the RAM 306 in the present discussion, in alternative embodiments of the present invention may include non-volatile memory, such as battery backed-up RAM, or other forms of non-volatile memory such as FLASH, EEPROM, or other types of non-volatile memory as are known to those of ordinary skill in the art. Additionally, although not shown in FIG. 3, the game carousel 101 may include storage memory communicatively coupled with the CPU 304. Storage memory may include non-volatile storage devices such as battery backed-up RAM, FLASH, EEPROM, a hard disk drive, R-W CD, ZIP drive, floppy drive, and other such storage devices as are known to those of ordinary skill in the art. The storage memory adds significant amounts of non-volatile memory that may be utilized by the game carousel 101 to store, for example, a large database of information relating to many different game codes and associations with different types of physical media, such as those shown in FIG. 2.

Software operating systems provide the interface between the various pieces of hardware and enable all the programs defining the games. The operating system supervises the hardware and software resources, i.e., processor, memory, disc space, and others, of the game system. Often, multiple requests for CPU time or memory access are received simultaneously. The operating system acts as gatekeeper to decide which requests get satisfied in which order. In this way, the operating system can maximize the system's resources.

The transceiver 308 includes, in this example, a receiver 314, a transmitter 316, and a switch 318. The transmitter 316 and receiver 314 are coupled via the antenna switch 318 to the antenna 310. For transmit operations, the antenna switch 318 couples the transmitter 316 to the antenna 310. Similarly, for receive operations, the antenna switch 318 couples the antenna 310 to the receiver 314. Other circuit configurations and device arrangements for a transceiver 308 should be obvious to those of ordinary skill in the art in view of the present discussion.

The media interface 302, in this example, provides housing and interconnection for various physical media types. The game carousel 101 is operable to access any single game media residing within the media interface 302 at a particular time. In another exemplary embodiment, the game carousel 101 is able to simultaneously access multiple game media. The game carousel 101 can transmit game code in multiple formats either via a wired link and/or via a wireless link. In one example, the game carousel 101 can transmit game code via any individual or combination of a wireless network, such as via a wireless local area network (LAN), a wireless wide area network (WAN), a wired LAN, and a wired WAN such as the Internet, using either transceiver 308 or wired port 320. The power supply 312 can include a battery, an A/C power supply, or a combination of both, such as a rechargeable battery with an AC power supply, or other power source as is well known to those of ordinary skill in the art.

Game Console

Referring again to FIG. 1, the game console 112 is part of the exemplary system 100 that allows a player (a user) to interact with a game program contained on a particular game media and wirelessly transmitted to the game console 112 by the game carousel 101. The game console 112 shown in FIG. 1 has a display 102 for displaying graphical information in a way that can be visually interpreted by a player. However, the game console 112 can be communicatively coupled to a separate display device, such as a TV or a monitor, and does not necessarily have to include a display 102. The game console 112 also includes interactive buttons 104 that allow the player to provide user input to the system 100. By manipulating each of the buttons 104 at various times, the player can interact with a video game. The signals can then be interpreted by the game software and a reply issued in accordance with the player's performance, based on the game's objectives and criteria. Buttons 104 also allow a player to cause the game console 112 to send signals to the game carousel 101. Additionally, the game console 112 is provided with function buttons 106, for turning the console 112 on and off or for placing the game into various modes. Furthermore, the game console 112 can be provided with one or more ports 108 for connecting peripheral devices, such as joysticks, Internet connections, network connections, additional video display devices, as well as physical game media, and more. The game console 112, in this example, includes an antenna (not shown) or other wireless communication link interface, such as infrared or ultrasound wireless interfaces, in order for the game console 112 to wirelessly communicate with the game carousel 101.

License

In one embodiment of the present invention, one or all of the games may have associated with them licensing agreements (licensing contracts), which mandate, among other things, the maximum number of players (e.g., the maximum contemporaneous instances of executing game code associated with a single physical game media) that may access a single physical game media at a single time. The licensing contracts make it necessary for the game carousel 101 (and optionally also the game consoles 112) to monitor how many and/or which game consoles 112 are contemporaneously accessing a game. This restriction is typically intended to prevent unauthorized distribution of copies of a game. It may also be a licensing requirement that only one game console 112 be allowed to access a game 400 at any particular time. These license contract requirements may be represented by at least one licensing parameter located in any combination of the game media 400, the game carousel 101, and the game console 112. By monitoring the licensing parameter, and comparing requests for game code to the at least one licensing parameter, in accordance with alternative embodiments of the present invention, any of the game media 400, the carousel 101, and the game console 112, can control whether the request for game code complies (does not violate) the licensing contract associated with the game code. In one embodiment, the CPU 304 acts as a comparator and compares the licensing parameters of a particular game to the number of game consoles requesting access to the single physical media. Based on the results of the comparison, the number of game consoles accessing the single physical media from exceeding the licensing parameter can be limited or restricted.

In one exemplary embodiment, a portion of the game is transmitted and the game console 112 and the game carousel 101 may continuously communicate and transmit data between each other for game play to continue. As shown in FIG. 4, if the physical media 400 is removed from the game carousel 101, the game carousel 101 may cease transmitting (represented by an “X”) information to the game console 112 and game play may no longer be possible on the game console 112. In an alternative embodiment, the carousel 101 actively signals the game console 112 to uninstall and/or erase the game from memory (represented by an “X”).

In a second exemplary embodiment, the entire game can be transmitted from the game carousel 101 to the game console 112 and stored in memory and/or non-volatile memory in the game console 112. In this exemplary embodiment, the game console 112 periodically receives a status signal from the game carousel 101 indicating that the physical media remains present (in communication with) the game carousel 101 and that the game console 112 has not traveled outside a physical boundary too great to allow wireless communication with the game carousel 101.

The game console 112 can also include a clock-timer module (not shown) for performing timed and/or periodic tasks. One such task, according to one embodiment of the present invention, includes transmitting a periodic query to the game carousel 101 for confirmation of the presence of the physical game media in (or communicatively coupling with) the game carousel 101. If the physical game media is not present in, or communicatively coupling with, the game carousel 101, or if no reply is received from the game carousel 101, the game console 112 prevents further execution of the game code in the game console 112 where such game code is associated with the respective physical game media. In an alternative embodiment, the carousel 101 actively signals the game console 112 to uninstall and/or erase the game from memory. Alternatively, if the game console 112 does not receive a reply to a transmitted query, or does not receive a status signal at an expected time, the game console 112 may assume that it is out of range from the game carousel 101 or that the game carousel 101 has been powered down and, in either case, may halt execution of the game code and/or delete or uninstall the game from the memory and any non-volatile memory associated with the game console 112.

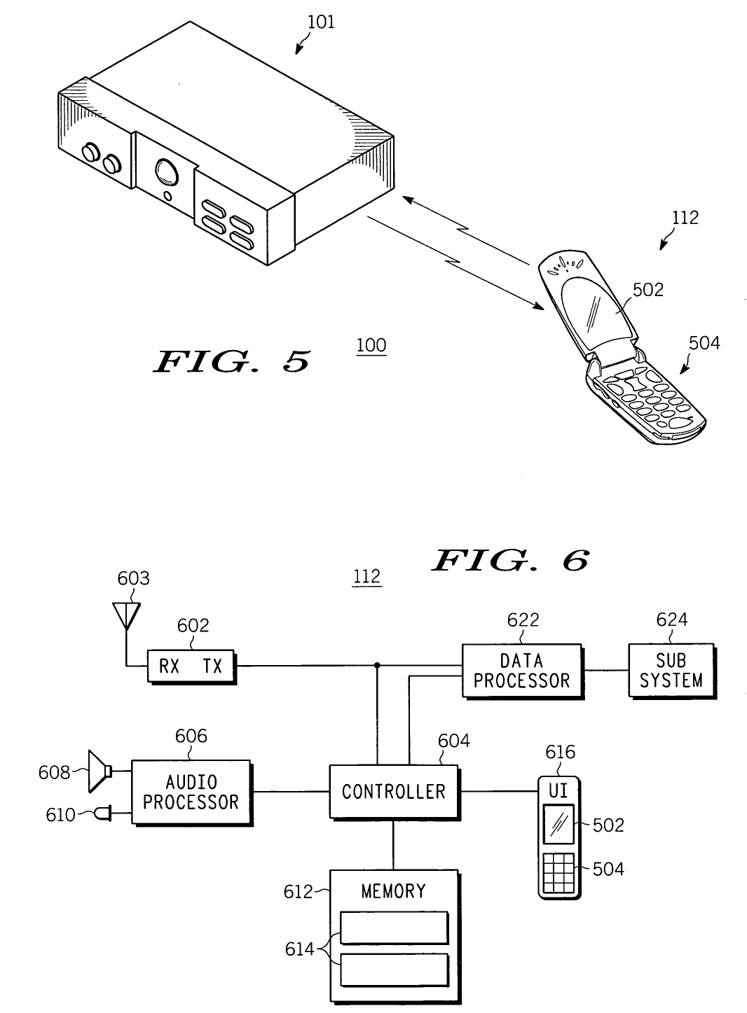

The game console 112 does not have to be a dedicated game-playing machine. Several devices could also be utilized, such as a cell phone, a PDA, a laptop computer, or any other computing device that, in one example, can facilitate wireless communication. FIG. 5 shows one specific embodiment of the present invention, where the game console 112 is a cellular telephone with a display 502 for viewing the graphical presentation of the game and a group of buttons 504 for interacting with the game.

Referring now to FIG. 6, a schematic block diagram of an exemplary cellular telephone 112 is shown. The cellular telephone 112 comprises a radio frequency transceiver 602 for communicating with one or more game carousels 101, one or more other game consoles 112, or communication system infrastructure equipment, typically via radio frequency signals communicated via an antenna 603. The operation of the cellular telephone 112 and the transceiver 602 is controlled by a controller 604. The cellular telephone 112 also comprises an audio processor 606 which processes audio signals received from the transceiver 602 to be played over a speaker 608, and it processes signals received from a microphone 610 to be delivered to the controller 604 and transceiver 602. The controller 604 operates according to game and instruction code stored in memory (which may comprise non-volatile memory) 612 of the cellular telephone 112. Various modules 614 of code and data are used for instantiating various functions, including the present game play.

To allow the user to operate the cellular telephone 112, the cellular telephone 112 comprises a user interface 616, including in this example a display 502 and a keypad 504. Other user interface devices should be obvious to those of ordinary skill in the art in view of he present discussion. For example, a joystick, a touch screen, a touchpad, buttons, switches, and other such user input devices may be included in an embodiment of the cellular telephone 112. Furthermore, it is contemplated that the cellular telephone 112 may comprise an additional data processor 622 for supporting a subsystem 624 attached to the mobile communication device (e.g., the cellular telephone 112) or integrated with the mobile communication device 112, such as, for example, a second device, a game playing machine, an external display, and more external devices as will be appreciated by those of ordinary skill in the art in view of the present discussion. The data processor 622, under control by the controller 604, can operate the subsystem 624 such as to acquire and transmit information.

The game carousel 101, shown in FIG. 5, is similar in appearance to a typical commercial set-top game box. Some examples of commercial set-top boxes are X-box™, PlayStation™, and GameCube™. The game carousel 101 can hold one or more game media for wireless communication, wired communication, or both, between the game carousel 101 and the game console 112, where each media contains code and data for one or more games. As an alternative to the game being displayed on the display 502 of the console 112, a display device (not shown) can be communicatively coupled, such as via wired link or wireless link, with the carousel 101. User inputs, such as commands and data, and other inputs to the console 112 may be transmitted to the game carousel 101. Game information may be displayed on the communicatively coupled display, such as a television or monitor, to the player (user). Alternatively, a display device can be incorporated in the game console 112 for displaying information to the user.

Physical Media Distributed via Mobile Phone

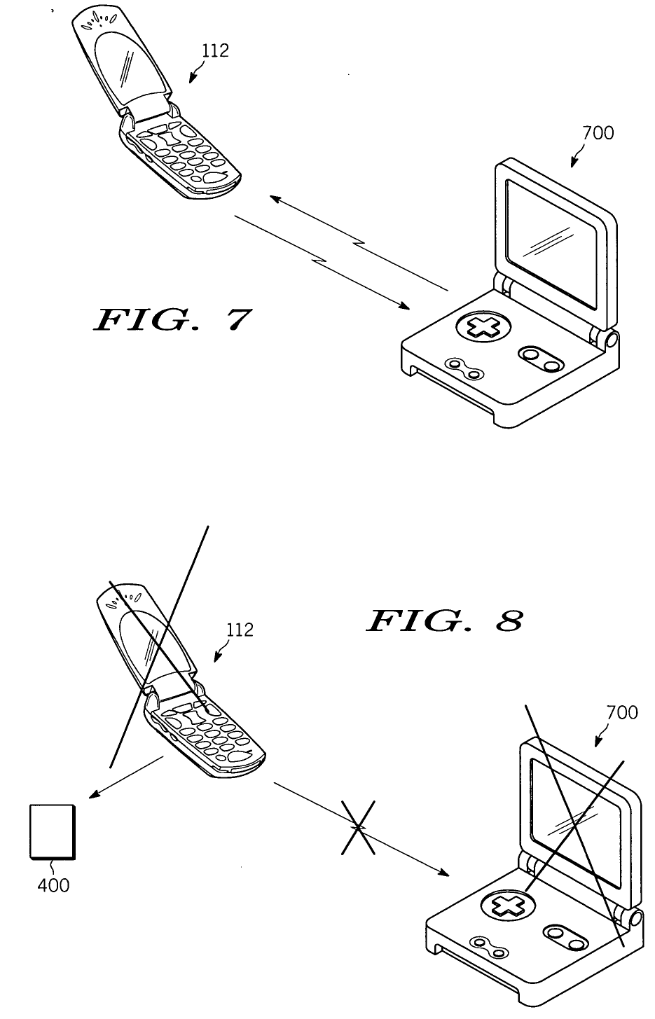

In another exemplary embodiment of the present invention, as shown in FIG. 7, a game console 112, illustrated as a cellular telephone, is used to purchase and/or download one or more games from the game carousel 101 or from a networked game distributor, such as via a cellular network operator, a wireless WAN and/or via the Internet. The game console 112, in this example, comprises an intermediate device 112. As an alternative to downloading game code, as another example, a physical media can be attached directly to the intermediate device 112.

As an intermediate device 112, the game console 112 no longer functions solely as a game console, but now can perform the functions previously assigned to/the game carousel 101, including enforcing the licensing parameters of each game. One or more game consoles, now labeled “700” in this example, communicate via wired link, wireless link, or both types of links, with the intermediate device 112 to facilitate game play on the game consoles 700.

It is also possible for a player to play the game on the intermediate device 112. In such a case, the intermediate device 112 also acts as a game console for that player. The intermediate device 112 need not be limited to a cellular telephone, but may be any device capable of wired, wireless, or both types of, communication with a console 700.

However, game play on the intermediate device 112 and game play on the game console 700 and/or other devices is controlled by the game code license associated with any particular game in the intermediate device 112. If the game code license does not allow simultaneous play on multiple devices, the intermediate device 112 may preempt game play on one or more separate game consoles 700 or other devices to ensure compliance with all licensing parameters associated with a particular game.

Other device(s) may be preempted from accessing a game in the intermediate device 112 by at least one of a selection by a user of the intermediate device 112, or by predefined access criteria stored in the intermediate device 112 such as an indication of the most recent player of a game being a candidate for preemption, or by another user access priority scheme as should be obvious to those of ordinary skill in the art in view of the present discussion. The predefined access criteria may comprise configuration data stored in non-volatile memory, jumper or switch settings that are readable by a controller of the intermediate device 112, and/or other mechanisms for configuring parameters of the intermediate device for specifying predefined access criteria as will be obvious to those of ordinary skill in the art in view of the present discussion.

As shown in FIG. 8, removal of the game code (represented by an “X”) from the intermediate device 112 may terminate game play (represented by an “X”) on the game consoles 700 and on the intermediate device 112. Termination of game play can include shutting down the game console 700 and/or removing or uninstalling the game code from the game console 700. Also, exceeding a specified maximum distance between devices, e.g., between the carousel 101 and the intermediate device 112 and/or between an intermediate device 112 and a game console 700, can also result in termination of game play. This termination of game play may include deletion of, and/or uninstallation of, the game code from the game console 700, the intermediate device 112, and/or the game carousel 101.

The intermediate device 112 can also include a clock-timer module (not shown) for performing timed and/or periodic tasks. One such task, according to one embodiment of the present invention, includes communicating a periodic query and response, by any one of a wired link, a wireless link, or a combination of both. Such communication of query and response can be by peer-to-peer communication or through network equipment, for continuous confirmation of the presence of the game code, e.g., the physical game media in (or communicatively coupling with) the carousel 101, and/or full compliance with the licensing parameters associated with each game. If a response confirms a negative status to any of the previously-mentioned conditions, the intermediate device 112 prevents further execution of the game code on the game console 700 and/or on the intermediate device 112 itself.

Alternatively, if the intermediate device 112 does not receive a response to a transmitted query, or does not receive a status signal at an expected time, the intermediate device 112, in this example, assumes that it is out of range from the network equipment or game carousel 101, that the network equipment has been powered down, or that the game carousel 101 has been powered down, and, in either case, may halt execution of the game code and transmit a delete or uninstall instruction to the game console 700 and further may delete and/or uninstall the game code from the memory of the intermediate device 112.

Similarly, according to the present example, the game console 700 includes a clock-timer module (not shown) for performing timed and/or periodic tasks. One such task includes transmitting a periodic query to the intermediate device 112 for continuous confirmation of the presence of game code in the intermediate device's memory or, in one embodiment, the physical game media in (or communicatively coupling with) the intermediate device 112. If the physical game media is not present in, or communicatively coupling with, the intermediate device 112, or if no reply is received from the intermediate device 112, the game console 700 prevents further execution of the game code in the game console 700. Such prevention of further execution at the game console 700 may include halting execution of the game code, and deleting and/or uninstalling game code from the memory of the game console 700.

Alternatively, if the game console 700 does not receive a reply to a transmitted query, or does not receive a status signal at an expected time, the game console 700 may assume that it is out of range from the intermediate device 112 or that the intermediate device 112 has been powered down and, in either case, may halt execution of the game code and delete and/or uninstall the game code from the memory of the game console 700.

Physical Media Sourced from Carousel and Distributed via Mobile Phone

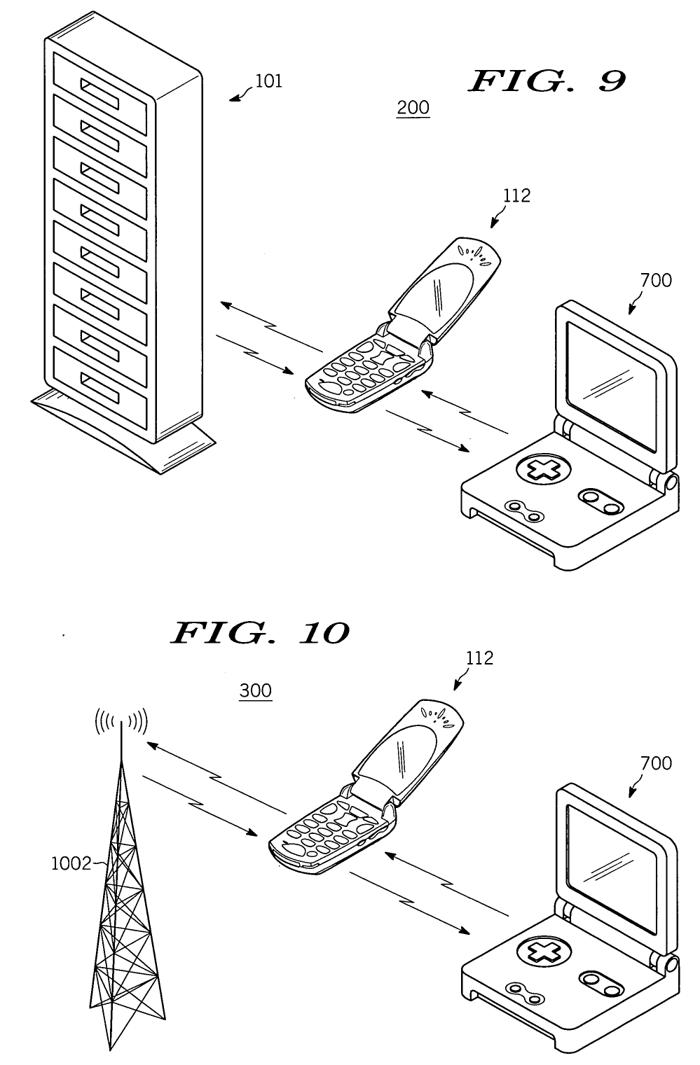

FIG. 9 shows a system 200, which includes a game carousel 101, an intermediate device 112, and a game console 700. The game carousel 101 holds one or more games in the form of physical media. In this exemplary embodiment, an intermediate device 112 that is in communication with, and/or within range of, the carousel 101 becomes a conduit for a game console 700 to access the games originally stored on the carousel 101.

In this embodiment, a game console 700 can access a game by communicating directly with the intermediate device 112 and in this way communicating indirectly with the game carousel 101. The intermediate device 112 then submits a request for access to the game to the game carousel 101. The game code, or a portion of the game code, is then transmitted to the intermediate device 112. If the licensing parameters stored at the intermediate device 112 allow access to the game code stored in memory in the intermediate device 112, then the game code can be made available to one or more game consoles 700 in accordance with the licensing permissions represented by the licensing parameters.

The intermediate device 112 can also include a clock-timer module (not shown) for performing timed and/or periodic tasks. One such task, according to one embodiment of the present invention, includes transmitting a periodic query to the game carousel 101 for continuous confirmation of the presence of the physical game media in (or communicatively coupling with) the game carousel 101. If the physical game media is not present in, or communicatively coupling with, the game carousel 101, or if no reply is received from the game carousel 101, the intermediate device 112 prevents further execution of the game code in the game console 700 where such game code is associated with the respective physical game media. Alternatively, if the intermediate device 112 does not receive a reply to a transmitted query, or does not receive a status signal at an expected time, the intermediate device 112 may assume that it is out of range from the game carousel 101 or that the game carousel 101 has been powered down and, in either case, may halt execution of the game code and transmit a delete or uninstall instruction to the game console 700 and further may delete and/or uninstall the game code from the memory of the intermediate device 112.

In a similar fashion, the game console 700 can include a clock-timer module (not shown) for performing timed and/or periodic tasks. One such task, according to one embodiment of the present invention, includes transmitting a periodic query to the intermediate device 112 for continuous confirmation of the presence of the physical game media in (or communicatively coupling with) the game carousel 101 or the intermediate device 112 itself. If the physical game media is not present in, or communicatively coupling with, the game carousel 101, the game console 700 prevents further execution of the game code in the game console 700 where such game code is associated with the respective physical game media. Alternatively, if the game console 700 does not receive a reply to a transmitted query, or does not receive a status signal at an expected time, the game console 700 may assume that it is out of range from the intermediate device 112 or that the intermediate device 112 has been powered down and, in either case, may halt execution of the game code and delete and/or uninstall the game code from the memory of the game console 700.

It may be possible for a player to play the game on the intermediate device 112. In such a case, the intermediate device 112 also acts as a game console for that player. Additionally, the intermediate device 112 need not be limited to a cellular telephone, but may be any device capable of wired communication, or wireless communication, or both types of communication, such as with a console 700, a carousel 101, or other game distribution device, depending on the particular implementation of a gaming system according to the present invention.

However, play on the intermediate device 112 can be done simultaneous with play on the game console 700 and/or other devices if the game code license allows this use. If the game code license does not allow simultaneous play, the intermediate device 112 may preempt game play on one or more game consoles 700 or other devices to ensure compliance with all licensing parameters.

The user of the intermediate device 112 may decide which other device(s) are preempted, or the intermediate device 112 may use predefined access criteria, such as the most recent player being preempted from further use, or other user access priority scheme, as should be obvious to those of ordinary skill in the art in view of the present discussion. The predefined access criteria may comprise configuration data stored in non-volatile memory, jumper or switch settings that are readable by a controller of the intermediate device, and/or other mechanisms for configuring parameters of the intermediate device for specifying predefined access criteria as will be obvious to those of ordinary skill in the art in view of the present discussion.

Game Code Acquired and distributed via Mobile Device

Referring now to FIG. 10, a system 300 is shown, which includes a game console 700, an intermediate device 112 and a provider network 1002. In this system 300, the intermediate device 112 provides a means for acquiring and accessing games from the provider distribution network 1002. In this system, the intermediate device 112 assumes the functions of the game carousel described in the previous embodiments of the present invention.

The intermediate device 112 purchases and/or downloads the game code from a networked or local game distributor, e.g., via kiosk or link cable, such as via a wireless network 1002 and/or via the Internet. The intermediate device 112 no longer functions solely as a game console, but now performs the functions previously assigned to the game carousel 101, including storing one or more games, transmitting all or portions of the game codes to one or more remote game consoles 700, and enforcing the licensing parameters of each game.

It is also possible for a player (user) to play the game on the intermediate device 112. In such a case, the intermediate device 112 also acts as a game console for that player. The intermediate device 112 need not be limited to a cellular telephone, but may be any device capable of wired communication and/or wireless communication with a console 700.

However, play on the intermediate device 112 can be done simultaneous with play on one or more of the game consoles 700 and/or other devices if the game code license allows this use. If the game code license does not allow simultaneous play, the intermediate device 112 may preempt game play on one or more game consoles 700 or other devices to ensure compliance with all licensing parameters stored in the intermediate device 112.

The user of the intermediate device 112 may select which other device(s) is (are) preempted, or the intermediate device 112 may use predefined access criteria, such as the most recent player being preempted from further use, or other user access priority scheme as should be obvious to those of ordinary skill in the art in view of the present discussion. The predefined access criteria may comprise configuration data stored in non-volatile memory, jumper or switch settings that are readable by a controller of the intermediate device, and/or other mechanisms for configuring parameters of the intermediate device 112 for specifying predefined access criteria as will be obvious to those of ordinary skill in the art in view of the present discussion.

Removal of the game code from the intermediate device 112 may terminate game play on the game console 700 and the intermediate device 112. Termination of game play can include shutting down the game console 700 or removing and/or uninstalling the game code from the game console 700. Also, exceeding a specified maximum distance between devices, i.e., between any two of the network equipment 1002, intermediate device 112, or game console 700, can also result in termination of game play, which may include deletion of, and/or uninstallation of, the game code from the game console 700 and/or the intermediate device 112.

The intermediate device 112 can also include a clock-timer module (not shown) for performing timed and/or periodic tasks. One such task, according to one embodiment of the present invention, includes transmitting a periodic query to the network equipment 1002 for continuous confirmation of the presence of the game code, physical game media in (or communicatively coupling with) a server machine coupled to the network 1002, or confirmation of full compliance with the licensing parameters associated with each game. If a reply from the network equipment 1002 confirms a negative response to any of the previously-mentioned conditions, the intermediate device 112, in a manner such as has been discussed above with reference to other examples, prevents further execution of the game code on the game console 700 and/or on the intermediate device 112 itself.

Alternatively, if the intermediate device 112 does not receive a reply to a transmitted query, or does not receive a status signal at an expected time, the intermediate device 112, in this example, may assume that it is out of range from the network equipment 1002 or that the network equipment 1002 has been powered down and, in either case, may halt execution of the game code and transmit a delete or uninstall instruction to the game console 700 and delete or uninstall the game from the memory of the intermediate device 112.

Similarly, the game console 700 includes a clock-timer module (not shown) for performing timed and/or periodic tasks. One such task, according to one embodiment of the present invention, includes transmitting a periodic query to the intermediate device 112 for continuous confirmation of the presence of game code in the intermediate device's memory. If the game code is not present in the intermediate device 112, or if no reply is received from the intermediate device 112, the game console 700 prevents further execution of the game code in the game console 700.

Alternatively, if the game console 700 does not receive a reply to a transmitted query, or does not receive a status signal at an expected time, the game console 700 may assume that it is out of range from the intermediate device 112 or that the intermediate device 112 has been powered down and, in either case, may halt execution of the game code and delete and/or uninstall the game code from the memory of the game console 700.

Game Cartridge Acting as a Game Carousel

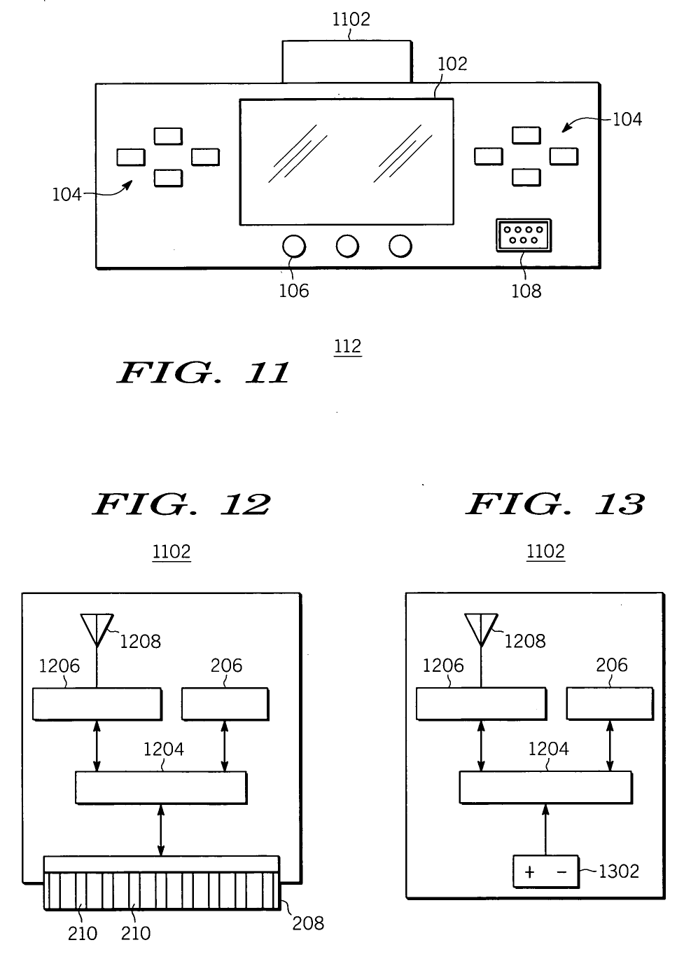

A wireless game cartridge 1102 is shown in FIG. 11 inserted into a wireless communication device such as a cellular telephone 112 acting as a game console 112. However, the wireless cartridge 1102 does not need to be inserted into the game console 112. The wireless cartridge 1102 can function on its own without the need for being inserted into another device.

The wireless plug-in game cartridge 1102 is shown in detail in FIG. 12. It includes a memory 206 for storing, among other things, the cartridge or game console identification data, player information, and game information. In one embodiment, the memory 206 is connected to a processor 1204 that is communicatively coupled to interface 208. The interface 208 has a plurality of conductive areas 210 that electrically couple the cartridge 1102 to the game console 112 or to a game carousel 101 so that the game instructions can be read and interpreted by a processor in the game console 112 or game carousel 101.

The processor 1204 can be utilized to access the memory 206 and transfer data contained in the memory 206 to the interface 208 or through a controller 1206 and antenna 1208 for wireless transmission to a remote receiver. Alternatively, the memory 206 and controller 1206 can be directly connected to the interface connector 208. Interface connector 208 is the interface between the wireless plug-in cartridge 1102 and the game console 112 in this example. In such a configuration, a processor contained within the game console 112 can perform the functions described above with regard to the processor 1204 shown in the exemplary wireless plug-in game cartridge 1102. Alternatively, a game console 112 can be provided with an antenna for wireless communication with the wireless plug-in cartridge 1102. Note that the particular game console 112 in wireless communication with the wireless plug-in game cartridge 1102 may be remotely located with respect to (and optionally having no physical connection with) the wireless plug-in game cartridge 1102. The wireless plug-in game cartridge 1102 could be connected to a first game console 112 while a second game console is in wireless communication with the wireless plug-in game cartridge 1102.

In still another exemplary embodiment, as illustrated in FIG. 13, a game media containing device, such as a game cartridge 1102, contains all of the components of the game carousel 101 described above, plus a portable, removable power source 1302 such as a battery, and the game media containing device 1102 itself serves as the game carousel 101. The game media containing device 1102, in this example, is equipped with a wireless transceiver 1206 and is capable of transmitting game information to a game console 112 requesting access to game code. While all game code licensing requirements are met, until the game media containing device 1102 and game console 112 reach a distance that exceeds the maximum wireless transmission range, the game console 112 can access the game code stored in the game media containing device 1102. In this embodiment, a player (user) can easily carry the game media containing device 1102 such as in a clothing pocket, on a belt, or any other similar portable carrying method. The game media containing device 1102 can also be located in a place near where a player may be playing a game, such as on furniture in a room. In this embodiment, a player could access and play a game in their room, even if they don't know where the game cartridge 1102 is located. The game cartridge 1102 limits use of the game (that is stored in the game cartridge 1102) to the parameters of the license agreement associated with the game.

Method

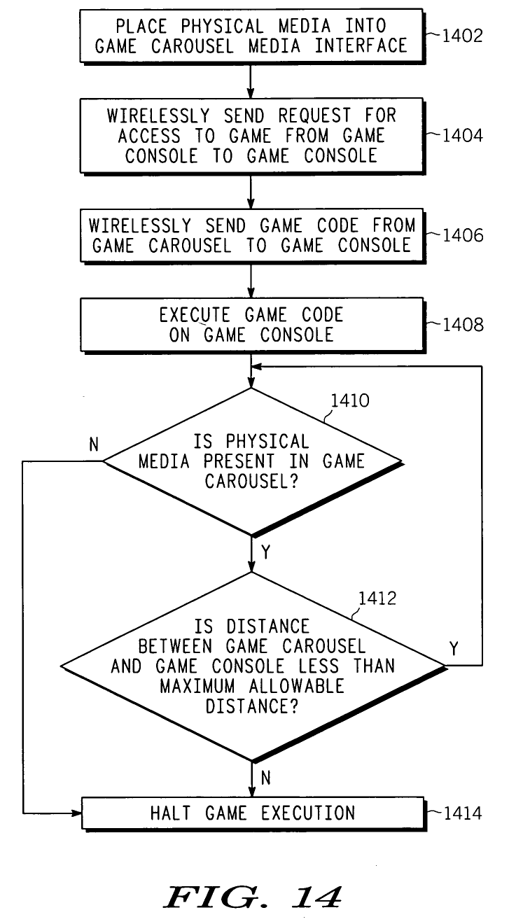

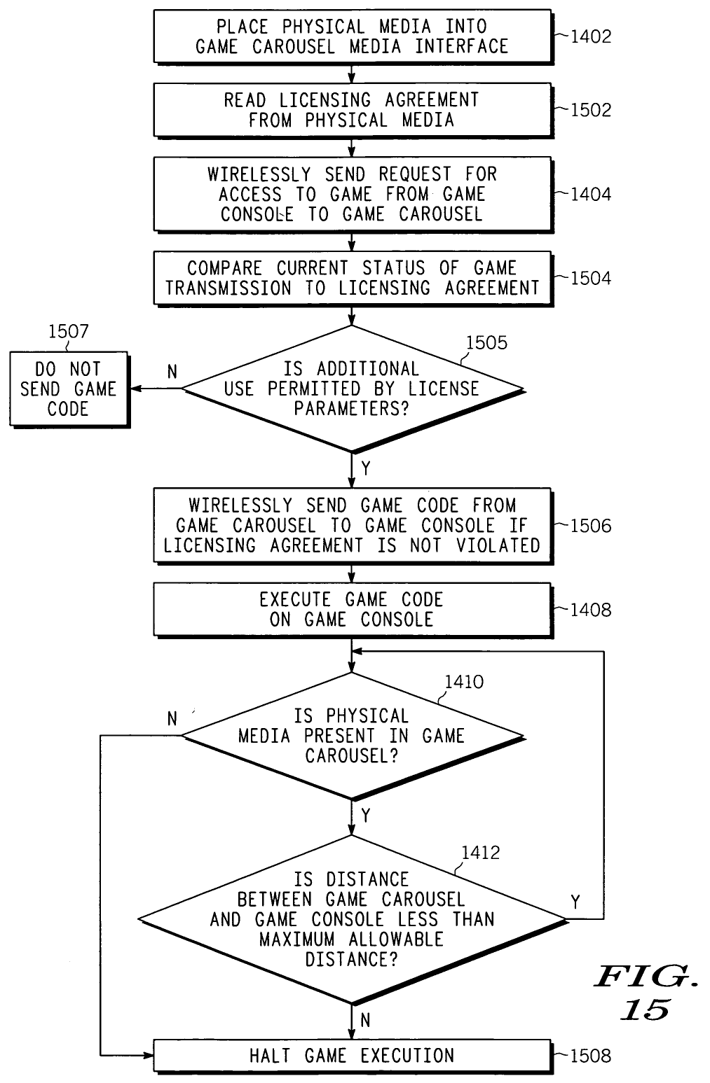

Referring now to FIG. 14, a flow chart illustrates an exemplary operational sequence of the present inventive system 100. In step 1402, a physical media is placed within the media interface 302 of the game carousel 101. This step could include placing multiple games contained on several of the same type of media, multiple games contained on the same single media, or multiple games contained on differing types, or formats, of media within the game carousel 101. In step 1404 a request from a game console 112 for access to a game contained on a physical media currently residing in, or communicatively coupling with, the game carousel 101 is received by the game carousel 101. If the media is physically present, the game carousel 101 wirelessly transmits at least a portion of the game code to the game console 112, at step 1406. After the game is received by the game console 112, at step 1408, the game code 112 is executed by the game console 112 and game play can take place. In one embodiment, a portion of the game is transmitted and the game console 112 and the game carousel 101 must continuously communicate and transmit data between each other for game play to continue. In this embodiment, if the physical media is removed from the game carousel 101, at step 1410, the game carousel 101 may cease transmitting game code information to the game console 112, in step 1414, and game play may no longer be possible on the game console 112. Additionally, the carousel 101 could also notify the game console 112 to halt the game and remove it from memory. Similarly, the game carousel 101 (and/or the game console 112) monitors the distance between the game carousel 101 and the game console 112 and halts game play if a maximum distance is exceeded, at step 1412.

Looking now to FIG. 15, a licensing agreement (licensing contract) is associated with a game (e.g., with game code). The flow begins, as previously described in FIG. 14, with the media being placed into the game carousel 101 media interface 302, at step 1402. Next, a licensing agreement is interpreted by the game carousel 101, at step 1502. The licensing agreement is represented in the game carousel 101 by at least one licensing parameter associated with the game code. Alternatively, the licensing agreement could be partially or wholly represented in the console 112, with the console 112 acting as the intermediate device. After receiving a request from a game console 112 for access to a game, at step 1404, the game carousel 101 compares the current status of the game use permissions to the licensing contract as represented in the game carousel 101 by the at least one licensing parameter, at step 1504. In this way, the game carousel is able to ensure, in step 1505, that the game carousel 101 is complying with the manufacturer's licensing contract and that no copyright laws are being violated due to unauthorized copies and distributions. If the license contract may be broken, game code is not sent, step 1507. However, if the license contract may not be violated, the game code is sent to the requesting game console, at step 1506. While physical media continues to be present in, or in communication with, the game carousel 101, and while the maximum distance between the game console and the game carousel is not exceed, then game code is permitted to continue to execute in the game console, at steps 1408, 1410, 1412. Otherwise, if physical media has been removed or the maximum distance has been exceeded, then game execution terminates, in step 1508, in a manner as has already been discussed above with reference to other examples.

Licensing Divided Between Consoles

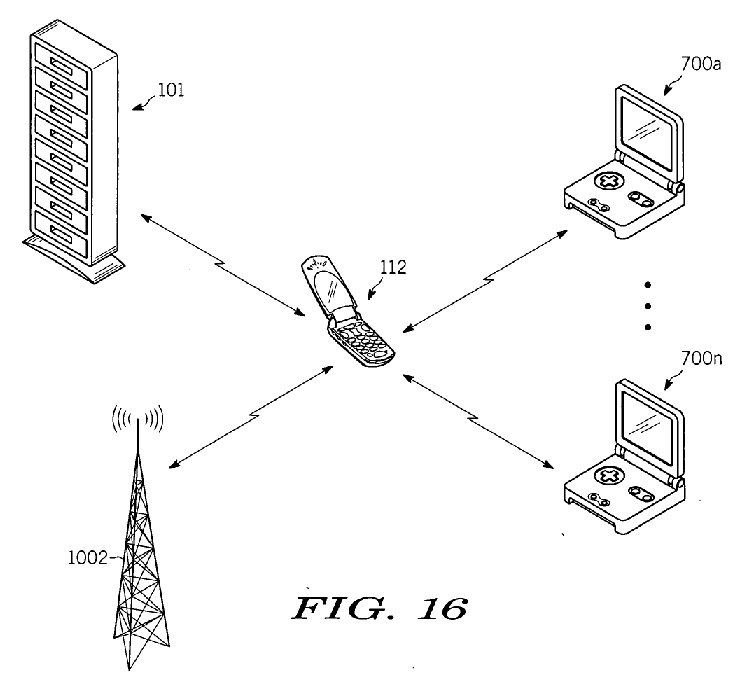

FIG. 16 illustrates another exemplary embodiment of the present invention. In the system of FIG. 16, a game carousel 101 distributes an entire game code to an intermediate device 112. The game carousel 101 has network capabilities for distributing the game code and maintaining, or periodically establishing communication with, the intermediate device 112. The intermediate device 112 takes with it the game code and the licensing parameters associated with the game code, leaving the game carousel 101 with diminished capabilities for using the licensed game code.

The intermediate device 112 may be out of range or unable to connect to the game carousel 101 for periods of time. For this reason, the intermediate device 112 is tasked with enforcing the licensing parameters of the particular game code stored in the intermediate device 112. The intermediate device 112 can then act as a game carousel to other game consoles 700a-n in communication with the intermediate device 112. Alternatively, the intermediate device 112 can transfer the entire game code and licensing parameters to a game console 700, which is then able to execute the game code without the assistance of the intermediate device 112. The game console 700 is, however, required to enforce the licensing parameters associated with the one or more game codes received from the intermediate device 112.

An example of this configuration is as follows: A family travels to a vacation spot. Before leaving the house, the father downloads at least one copy of game code from a stationary game carousel 101 (that has licenses for contemporaneously executing two or more copies of the game code) onto his cellular telephone 112, which then becomes an intermediate device 112. The two kids can play the game in the car by either using the father's cellular phone, or by linking to the cellular phone, via wired or wireless link, with their game consoles, such as a GameBoy™. Once the family arrives at the vacation spot, the father and mother may wish to separate and take different paths. The father can then transfer at least one copy of the game code to the mother's cellular phone, which becomes an intermediate device 112 and acts as a separate game carousel for the game console of one or both of the kids going along with the mother. The mother's cellular phone now maintains licensing parameters, such a number of users, amount of time each user gains access, number of times accessed, etc. The mother's cellular phone can periodically communicate with either the father's phone or with the main carousel back at home over a wireless network and/or the Internet to ensure that the physical media is still present in the main game carousel back at home.

It is also possible for a player to play the game on either of the intermediate devices 112. In such a case, the intermediate device 112 also acts as a game console for that player. The intermediate device 112 need not be limited to a cellular telephone, but may be any device capable of wired or wireless communication with a console 700.

However, play on the intermediate device 112 can be done simultaneous with play on one or more the game consoles 700 and/or other devices if the game code license allows this. If the game code license does not allow simultaneous play, the intermediate device 112 may preempt game play on one or more game consoles 700 or other devices to ensure compliance with all licensing parameters.

The intermediate device user may decide which other device(s) is (are) preempted, or the intermediate device 112 may use predefined access criteria, such as the most recent player being preempted, or other user access priority scheme as should be obvious to those of ordinary skill in the art in view of the present discussion. The predefined access criteria may comprise configuration data stored in non-volatile memory, jumper or switch settings that are readable by a controller of the intermediate device, and/or other mechanisms for configuring parameters of the intermediate device for specifying predefined access criteria as may be obvious to those of ordinary skill in the art in view of the present discussion.

Removal of the game code from the intermediate device 112 or the game carousel 101 may terminate game play on the game consoles 700 and the intermediate device 112. Termination of game play can include shutting down the game console 700 or removing and/or uninstalling the game code from the game console 700. Also, exceeding a specified maximum distance between devices, i.e., between intermediate devices 112, or between an intermediate device and a game console 700, can also result in termination of game play at a game console 700, which may include deletion of, and/or uninstallation of, the game code from the game console 700, the intermediate device 112, and/or the game carousel 101.

The intermediate device 112 can also include a clock-timer module (not shown) for performing timed and/or periodic tasks. One such task, according to one embodiment of the present invention, includes transmitting a periodic query through network equipment 1002 for continuous confirmation of the presence of the game code, physical game media in (or communicatively coupling with) the carousel 101 coupled to the network 1002, or full compliance with the licensing parameters associated with each game. If a response from the network equipment 1002 confirms a negative status for any of the previously-mentioned conditions, the intermediate device 112 prevents further execution of the game code on the game console 700 and/or on the intermediate device 112 itself.

Alternatively, if the intermediate device 112 does not receive a reply to a transmitted query, or does not receive a status signal at an expected time, the intermediate device 112 may assume that it is out of range from the network equipment 1002, that the network equipment 1002 has been powered down, or that the game carousel 101 has been powered down, and, in either case, may halt execution of the game code and transmit a delete or uninstall instruction to the game consoles 700 and delete and/or uninstall the game from the intermediate device's memory.

Similarly, the game consoles 700 may include a clock-timer module (not shown) for performing timed and/or periodic tasks. One such task, according to one embodiment of the present invention, includes transmitting a periodic query to the intermediate device 112 for continuous confirmation of the presence of game code in the intermediate device's memory or, in one embodiment, the physical game media in (or communicatively coupling with) the intermediate device 112. If the physical game media is not present in, or communicatively coupling with, the intermediate device 112, or if no reply is received from the intermediate device 112, the game console 700 prevents further execution of the game code in the game console 700.

Alternatively, if the game console 700 does not receive a reply to a transmitted query, or does not receive a status signal at an expected time, the game console 700 may assume that it is out of range from the intermediate device 112 or that the intermediate device 112 has been powered down and, in either case, may halt execution of the game code and delete and/or uninstall the game from the game console's 700 memory.

In another embodiment of the present invention, the game carousel 101 can maintain records of which game consoles 112 have access to which games on the game carousel 101 and for what amount of time. In this way, a player can later be billed for receiving access to each game. Further, in such a case, there may not be a need to preempt further use by a game console if an additional license could be automatically paid for by the game carousel 101 when it detects a condition requiring additional license. Payment could then be effected automatically such as via pre-arranged payment mechanisms and pre-authorization of a financial arrangement for making payment for additional license. Those of ordinary skill in the art will understand many alternative mechanisms and ways to authorize payment for additional licenses in view of the present discussion. For example, an online transaction via the Internet could be automatically effected by the game carousel 101 using pre-arranged bank information, or credit card information, for the online transaction.

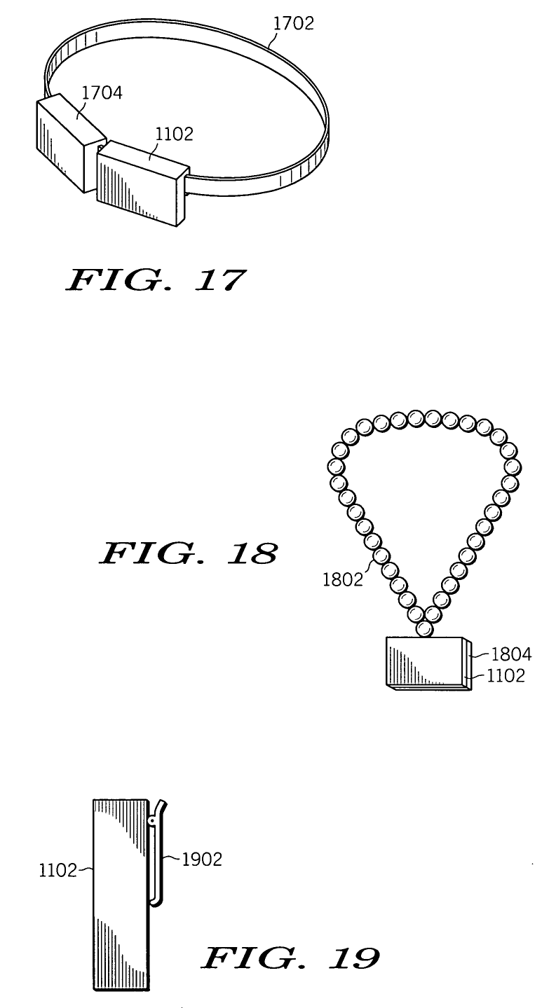

FIGS. 17-19 show the wireless gaming cartridge 1102 provided with various attachments for making the cartridge 1102 wearable on a user. In FIG. 17 two cartridges 1102 and 1704 are attached to a strap 1702, which could be a belt, a bracelet, a headband, or the like. A user can attach the strap 1702 to their body and easily carry the cartridges with them. Any number of cartridges can be attached to the strap 1702 and worn on a user.

Similarly, FIG. 18 shows two wireless gaming cartridges 1102 and 1804 attached to a necklace 1802. The necklace 1802 can be worn around the neck of a user so that the cartridge conveniently travels with the user. Any number of cartridges can be attached to the necklace and worn by a user.

FIG. 19 shows the wireless gaming cartridge 1102 in one further embodiment, where a clip 1902 is attached. The clip can be slipped over a belt, pants, or other clothing to attach the cartridge 1102 to a user. The cartridge 1102 then conveniently travels with the user.

In light of the previous discussion, those of ordinary skill in the art will find it obvious that multiple cartridges 1102 can be provided on a single belt or bracelet, as shown in FIG. 17, or on a necklace as shown in FIG. 18. Additionally, one or more cartridges 1102 can be worn in pockets on vests, shirts, pants, and the like. Other means of wearing game cartridges on a person's body should be obvious to those of ordinary skill in the art in view of the present discussion. For example, game cartridges may be incorporated in, and/or attached to, items of clothing and items of footwear that would be wearable, such as by a person.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A game containing device which provides housing and interconnection for various physical media types, the device comprising:
a controller;
a media interface, electrically coupled with the controller, for communicatively coupling with at least one physical media, the at least one physical media including game code; and
a wireless data communication transceiver, electrically coupled with the controller, for wirelessly communicating between the game containing device and at least one game console, and for, in response to wirelessly receiving a request from a game console, accessing the game code of the at least one physical media communicatively coupled with the media interface and providing to the game console at least a portion of the game code of the at least one physical media while the at least one physical media is communicatively coupled with the media interface.

2. The game containing device of claim 1, wherein the wireless data communication transceiver denies access to the game code by the game console after the at least one physical media discontinues communicatively coupling with the media interface.

3. The game containing device of claim 1, further comprising:
a licensing parameter associated with a single physical media of the at least one physical media, the licensing parameter specifying the number of game consoles that may contemporaneously access the game code of the single physical media; and
a comparator, communicatively coupled with the licensing parameter and the controller, to compare the licensing parameter to the number of game consoles requesting access to the single physical media, for preventing the number of game consoles accessing the single physical media from exceeding the licensing parameter.

4. The game containing device of claim 3, further comprising:
a predefined access criteria for determining a priority of access to the single physical media by each of the game consoles, if the number of game consoles requesting contemporaneous access to the single physical media exceeds the licensing parameter.

5. The game containing device of claim 1, further comprising:
a memory for storing a record of a game console's access to the game code of the at least one physical media.

6. The game containing device of claim 1, wherein the media interface further comprises at least two slots to couple to at least two physical media, each including game code.

7. The game containing device of claim 1, wherein the media interface couples with physical media of multiple physical formats.

8. A video gaming console comprising:
a controller;
a wireless transceiver, electrically coupled with the controller; and
a memory, electrically coupled with the controller;
wherein the wireless transceiver sends a request to a game containing device for wireless access to a game code in a physical game media communicatively coupled with the game containing device, and if access is granted by the game containing device, the wireless transceiver receives at least a portion of the game code and stores the at least a portion of the game code in the memory.

9. The video gaming console of claim 8, further comprising:
a clock-timer module, electrically coupled with the controller, for the controller periodically querying the game containing device for the continued communicatively coupling of the physical game media with the game containing device.

10. The video gaming console of claim 9, wherein the controller, in response to a determination that the physical game media discontinued communicatively coupling with the game containing device, preventing execution of the at least a portion of the game code.

11. The video gaming console of claim 10, wherein the controller, in response to a determination that the physical game media discontinued communicatively coupling with the game containing device, performing at least one of deleting the game code from the memory and uninstalling the game code from the memory.

12. A video gaming intermediate device, comprising:
a controller;
a wireless data communication transceiver, electrically coupled with the controller, and
a memory, electrically coupled with the controller, and
wherein the controller for wirelessly transmitting, via the wireless data communication transceiver, a request to a game containing device for wireless access to game code of a physical gaming media,
for storing in the memory the game code wirelessly received from the game containing device in the memory, and
for wirelessly communicating the game code from the memory to at least one game console.

13. The video gaming intermediate device of claim 12, further comprising:
a comparator, electrically coupled with the controller, for receiving at least one licensing parameter from the game containing device, and for comparing the at least one licensing parameter to a request received from the at least one game console requesting access to the game code.

14. The video gaming intermediate device of claim 13, wherein the controller for preventing access to the game code by the at least one game console if a comparison of the request to the at least one licensing parameter results in a determination that providing the requested access to the game code would violate a license contract associated with the game code.

15. A method of distributing an electronic game to at least one game console, the method comprising:
wirelessly receiving, at a game containing device, a request from at least one game console for access to game code associated with a physical game media;
confirming, at the game containing device, that the physical game media is communicatively coupled with the game containing device; and
wirelessly transmitting, upon confirmation that the physical game media is communicatively coupled with the game containing device, at least a portion of the game code to the at least one game console in response to the request.

16. The method of claim 15, further comprising:
monitoring whether the physical game media is communicatively coupled with the game containing device, and if the physical game media is determined to have stopped communicatively coupling with the game containing device then preventing execution of the game code at each of the at least one game console.

17. The method of claim 16, wherein:
the physical game media is determined to have stopped communicatively coupling with the game containing device when at least one of: the physical game media is removed from the game containing device, and the physical game media stops communicating with a media interface of the game console.

18. The method of claim 15, further comprising:
comparing a licensing parameter to at least one of:
the number of game consoles contemporaneously requesting access to the game code associated with the physical game media, and
the number of instances of a game code being executed by each of the at least one game console requesting access to the game code.

19. The method of claim 18, further comprising:
denying access to the game code by a game console requesting such access in response to the comparing of the licensing parameter resulting in a determination that such access would violate a license contract associated with the game code.

20. The method of claim 15, further comprising;
monitoring whether a game console of the at least one game console has stopped wireless communication with the game containing device, and if the game console is determined to have stopped such wireless communication then terminating execution of the game code at the game console.

21. A physical gaming media comprising:
memory for storing program and data, including for storing game code and at least one licensing parameter;
a controller, electrically coupled with the memory;
a wireless data communication transceiver, electrically coupled with the controller; and
a comparator, electrically coupled with the controller, for
wirelessly receiving a request, via the wireless data communication transceiver, for access to the game code by at least one game console;
comparing the request to the at least one licensing parameter; and
wirelessly transmitting the requested game code to the at least one game console if a comparison of the request to the at least one licensing parameter results in a determination that such access would comply with a license contract associated with the game code.
